(19) United States
(12) Patent Application Publication
(10) Pub. No.: US 2026/0249875 A1
(43) Pub. Date: Aug. 27, 2026

(54) AUTONOMOUS DRIVING CONTROL DEVICE AND METHOD

(71) Applicants: Hyundai Motor Company, Seoul (KR); Kia Corporation, Seoul (KR)

(72) Inventors: Jeong Woo KIM, Hwaseong-Si (KR); Sung Yoon YEO, Hwaseong-Si (KR); Seung Joon LEE, Hwaseong-Si (KR); Su Jung YOO, Hwaseong-Si (KR); Beom Jun KIM, Hwaseong-Si (KR)

(21) Appl. No.: 19/349,263

(22) Filed: Oct. 3, 2025

(30) Foreign Application Priority Data
Feb. 27, 2025 (KR) 10-2025-0026232

(51) Int. Cl. B60W 60/00; B60W 30/14; B60W 30/16; B60W 30/18; B60W 50/00

(52) U.S. Cl. CPC B60W 60/001; B60W 30/146; B60W 30/16; B60W 30/18159; B60W 50/0097; B60W 2520/10; B60W 2554/4042

(57) ABSTRACT

An apparatus of a host vehicle may comprise a communication interface configured to receive information associated with the host vehicle, wherein the information may comprise driving information, road information, and object information, a processor, and a memory storing the received information and at least one instruction. When executed by the processor communicating with the memory, the instruction is configured to cause the apparatus to determine, based on the stored information, that the host vehicle is in a road merging section, select, based on the determination and the stored information, a target vehicle to which yielding is to be performed, output a signal indicating the target vehicle and driving information of the target vehicle, and control, based on the signal, autonomous driving of the host vehicle.

### CROSS-REFERENCE TO RELATED APPLICATION

This application claims the benefit of priority to Korean Patent Application No. 10-2025-0026232, filed in the Korean Intellectual Property Office on Feb. 27, 2025, the entire contents of which are incorporated herein by reference.

### TECHNICAL FIELD

The present disclosure relates to an autonomous driving control device and method, and more specifically, to a technology for controlling the vehicle's driving by autonomously selecting a vehicle to be yielded in a road merging section.

### BACKGROUND

The matters described in this Background section are only for enhancement of understanding of the background of the disclosure, and should not be taken as acknowledgment that they correspond to prior art already known to those skilled in the art.

Roads may be classified into various types based on their shape, size, and function. Typically, a road is structured to either split into multiple roads or merge multiple roads into a single road. In this context, a road merging section, where multiple roads merge into a single road, often experiences traffic congestion. In particular, such congestion may lead to issues like cut-ins (where a vehicle unexpectedly merges into another lane).

Autonomous vehicles may perform longitudinal and lateral control of the vehicle in response to cut-ins by other vehicles or objects in close proximity within the road merging section. However, autonomous vehicles may control themselves without predicting other vehicles changing lanes in the road merging section, which may lead to an insufficient reduction of discomfort or tension.

A technology in autonomous driving control that alleviates discomfort in road merging sections is considered.

### SUMMARY

The present disclosure has been made to solve the above-mentioned problems.

An example of the present disclosure provides an autonomous driving control device and method capable of selecting a vehicle to be yielded in a road merging section and controlling the driving of a host vehicle.

The technical problems to be solved by the present disclosure are not limited to the aforementioned problems, and any other technical problems not mentioned herein will be clearly understood from the following description by those skilled in the art to which the present disclosure pertains.

According to the present disclosure, an apparatus of a host vehicle, the apparatus may comprise, a communication interface configured to receive information associated with the host vehicle, wherein the information may comprise driving information, road information, and object information, a processor, and a memory storing the received information and at least one instruction that, when executed by the processor communicating with the memory, is configured to cause the apparatus to, determine, based on the stored information, that the host vehicle is in a road merging section, based on the determination that the host vehicle is in the road merging section and the stored information, select a target vehicle to which yielding is to be performed, output a signal indicating the target vehicle and driving information of the target vehicle, and control, based on the signal, autonomous driving of the host vehicle.

The apparatus, wherein the at least one instruction, when executed by the processor communicating with the memory, is configured to cause the apparatus to, select, based on the stored information, a plurality of candidate vehicles from which the target vehicle is to be selected, based on driving information of at least one candidate vehicle of the plurality of candidate vehicles, select the target vehicle among the plurality of candidate vehicles, and steer, based on the signal, the host vehicle to yield to the target vehicle.

The apparatus, wherein the at least one instruction, when executed by the processor communicating with the memory, is configured to cause the apparatus to, based on a determination that the host vehicle is in a first section, determine not to select the plurality of candidate vehicles, and based on a determination that the host vehicle is in a second section, select the plurality of candidate vehicles.

The apparatus, wherein the at least one instruction, when executed by the processor communicating with the memory, is configured to cause the apparatus to, based on a determination that the host vehicle is in the road merging section, select the target vehicle.

The apparatus, wherein the at least one instruction, when executed by the processor communicating with the memory, is configured to cause the apparatus to, based on a position of the road merging section and a position of a candidate vehicle among the plurality of candidate vehicles, define a plurality of sections along a lane in which the host vehicle is driving, and wherein the plurality of sections may comprise the first section, the second section, and the road merging section.

The apparatus, wherein the at least one instruction, when executed by the processor communicating with the memory, is configured to cause the apparatus to determine a relative position of a rear edge of the at least one candidate vehicle with respect to a front edge of the host vehicle.

The apparatus, wherein the at least one instruction, when executed by the processor communicating with the memory, is configured to cause the apparatus to, predict a first time at which the at least one candidate vehicle reaches a boundary between the second section and the road merging section, predict a second time at which the host vehicle reaches the boundary, and predict, based on the host vehicle yielding to the at least one candidate vehicle, a deceleration of the host vehicle.

The apparatus, wherein the at least one instruction, when executed by the processor communicating with the memory, is configured to cause the apparatus to, determine whether the first time is less than or equal to the second time based on a relative position of a rear edge of the at least one candidate vehicle with respect to a front edge of the host vehicle and based on the host vehicle being in the second section, and determine, based on the relative position, whether the deceleration is greater than a threshold.

The apparatus, wherein the at least one instruction, when executed by the processor communicating with the memory, is configured to cause the apparatus to, based on the determination that the host vehicle is in the road merging section and cancelation of selection of the at least one candidate vehicle, identify a vehicle ahead of the host vehicle as the target vehicle.

The apparatus, wherein the at least one instruction, when executed by the processor communicating with the memory, is configured to cause the apparatus to, determine a target speed of the host vehicle, a maximum speed of the host vehicle, and an optimal speed of the host vehicle based on environment of the host vehicle and the stored information, determine a following speed at which the host vehicle follows the target vehicle, determine, based on the target speed, the maximum speed, the optimal speed, and the following speed, an average value of accelerations, and determine a driving speed of the host vehicle based on the average value of accelerations.

According to the present disclosure, a method performed by an apparatus of a host vehicle, the method may comprise, receiving, via a communication interface of the host vehicle, information associated with the host vehicle, wherein the information may comprise driving information, road information, and object information, storing the received information, determining, based on the stored information, that the host vehicle is in a road merging section, based on the determining of the host vehicle being located in the road merging section and the stored information, selecting a target vehicle to which yielding is to be performed, outputting a signal indicating the target vehicle and driving information of the target vehicle, and controlling, based on the signal, autonomous driving of the host vehicle.

The method, wherein the selecting of the target vehicle may comprise, based on the stored information, selecting a plurality of candidate vehicles from which the target vehicle to be selected, and based on driving information of at least one candidate vehicle of the plurality of candidate vehicles, selecting the target vehicle among the plurality of candidate vehicles, and wherein the controlling of the autonomous driving of the host vehicle may comprise, steering, based on the signal, the host vehicle to yield to the target vehicle.

The method, wherein the selecting of the plurality of candidate vehicles may comprise, based on a determination that the host vehicle is in a first section, determining not to select the plurality of candidate vehicles, and based on a determination that the host vehicle is in a second section, selecting the plurality of candidate vehicles.

The method, wherein the selecting of the target vehicle may comprise, based on a determination that the host vehicle is in the road merging section, selecting the target vehicle.

The method may further comprise, based on a position of the road merging section and a position of a candidate vehicle among the plurality of candidate vehicles, defining a plurality of sections along a lane in which the host vehicle is driving, wherein the plurality of sections may comprise the first section, the second section, and the road merging section.

The method, wherein the selecting of the target vehicle may comprise determining a relative position of a rear edge of the at least one candidate vehicle with respect to a front edge of the host vehicle, and selecting, based on the relative position, the target vehicle.

The method, wherein the selecting of the target vehicle may comprise, predicting a first time at which the at least one candidate vehicle reaches a boundary between the second section and the road merging section, predicting a second time at which the host vehicle reaches the boundary, and predicting, based on the host vehicle yielding to the at least one candidate vehicle, a deceleration of the host vehicle.

According to the present disclosure, a vehicle may comprise, a sensor, a driving control circuit configured to control autonomous driving of the vehicle, a processor, and a memory storing at least one instruction that, when executed by the processor communicating with the memory, is configured to cause the vehicle to, obtain, from the sensor, driving information of the vehicle, determine, based on the driving information, whether the vehicle is in a road merging section of a lane in which the vehicle is traveling, based on the determination of the vehicle being in the road merging section, select, based on the driving information, at least one candidate vehicle from at least one identified vehicle, determine, for each candidate vehicle of the at least one candidate vehicle, whether a merging event with the vehicle is likely to occur, based on a determination that the merging event is likely to occur, select a target vehicle from among the at least one candidate vehicle, based on driving behavior of the target vehicle and driving environment of the vehicle, determine a following speed of the vehicle for yielding to the target vehicle, output a signal indicating the following speed of the vehicle, and control, via the driving control circuit and based on the signal, autonomous driving of the vehicle.

The vehicle, wherein the at least one instruction, when executed by the processor communicating with the memory, is configured to cause the vehicle to determine whether the merging event is likely to occur by, determining a relative position of a rear edge of each of the at least one candidate vehicle with respect to a front edge of the vehicle, predicting a first time at which the at least one candidate vehicle is expected to reach a boundary between, a merging assessment section of the lane, and the road merging section, predicting a second time at which the vehicle is expected to reach the boundary, and based on the first time being earlier than the second time, for the vehicle to yield to the at least one candidate vehicle, predicting whether a deceleration of the vehicle exceeds a threshold deceleration value.

The vehicle, wherein the at least one instruction, when executed by the processor communicating with the memory, is configured to cause the vehicle to, determine a plurality of candidate speeds for the vehicle, wherein the plurality of candidate speeds comprise, a speed at which the vehicle maintains estimated time-of-arrival, a speed constrained by a detected road speed limit, and a speed determined based on the at least one candidate vehicle, determine a following speed at which the vehicle is able to maintain a safe distance from the target vehicle, determine an average value of accelerations corresponding to each of the plurality of candidate speeds and the following speed, and select, from among the plurality of candidate speeds and the following speed, a driving speed having a minimum average acceleration value.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a road merging section;

FIG. 2 shows an example of a vehicle system including an autonomous driving control device;

FIG. 3 shows an example of a configuration of a processor;

FIG. 4A, FIG. 4B, FIG. 4C, and FIG. 4D are diagrams for describing a host vehicle driving in a road merging section;

FIG. 5 shows an example of an autonomous driving control method;

FIG. 6 shows an example of an autonomous driving control method in detail; and

FIG. 7 shows an example of a computing system.

### DETAILED DESCRIPTION

Hereinafter, some examples of the present disclosure will be described in detail with reference to the exemplary drawings. In adding the reference numerals to the components of each drawing, it should be noted that the identical or equivalent component is designated by the identical numeral even if they are displayed on other drawings. Further, in describing the example of the present disclosure, a detailed description of well-known features or functions will be ruled out in order not to unnecessarily obscure the gist of the present disclosure.

In describing the components of the example according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., feature of selecting a vehicle to be yielded in a road merging section) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., feature of selecting a vehicle to be yielded in a road merging section) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., feature of selecting a vehicle to be yielded in a road merging section) described herein.

Minimum risk maneuver (MRM) operation(s) may also be controlled, for example, based on one or more features (e.g., feature of selecting a vehicle to be yielded in a road merging section) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., feature of selecting a vehicle to be yielded in a road merging section) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., feature of selecting a vehicle to be yielded in a road merging section) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

An autonomous driving level and/or autonomous driving activation/deactivation may also be controlled, for example, based on one or more features (e.g., feature of selecting a vehicle to be yielded in a road merging section) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

The present disclosure relates to techniques for enabling self-driving vehicles to handle road merging scenarios in a smoother and safer manner. In situations where vehicles from different roads converge into a single lane, aggressive acceleration or unexpected deceleration can lead to confusion and collisions. The disclosed technology allows a self-driving vehicle to determine which surrounding vehicle should be given priority to merge based on factors such as road layout, relative positions, and speeds. By adjusting its own speed and steering, the self-driving vehicle can ensure the merge happens smoothly and predictably, contributing to a more natural driving experience and reducing abrupt movements.

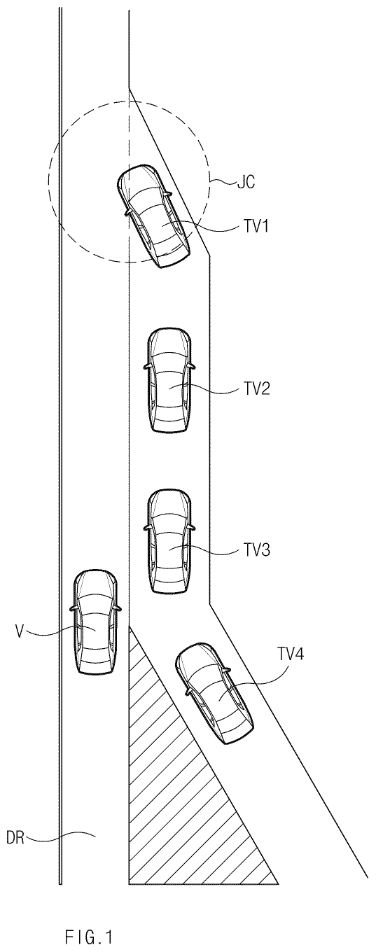

Hereinafter, examples of the present disclosure will be described in detail with reference to FIGS. 1 to 7.

FIG. 1 shows an example of a road merging section.

Referring to FIG. 1, a road merging section JC may be a section where traffic congestion occurs. For example, a cut-in of another vehicle into a host vehicle may occur (e.g., when a nearby vehicle abruptly merges without sufficient gap, when a driver misjudges speed or distance, or during rush hour traffic), which may cause an accident or worse congestion.

It is assumed that there is a road merging section JC ahead of a lane DR in which a host vehicle “V” is driving. Further, it is assumed that there are target vehicles TV1 to TV4 driving in a different lane from the host vehicle “V”, (e.g., an on-ramp lane, a merging auxiliary lane, or a converging traffic lane) which are expected to merge into the road merging section JC.

To solve the above problem, the present disclosure may select a vehicle to be yielded from among the target vehicles TV1 to TV4. Here, the vehicle to be yielded refers to a vehicle capable of passing via the road merging section JC before the host vehicle “V” (e.g., a faster-moving vehicle already closer to the merge point or a vehicle with higher priority under traffic rules). Further, the present disclosure may control the autonomous driving of the host vehicle “V” based on the driving information of the vehicle to be yielded.

As described above, the present disclosure may provide an autonomous driving control device that selects a target vehicle to be yielded in a road merging section and controls the driving of a host vehicle.

The autonomous driving control device according to the present disclosure may be provided inside the host vehicle “V”, or may be provided in an external system that communicates with the host vehicle “V” (e.g., a cloud server, a roadside unit, or a traffic control hub).

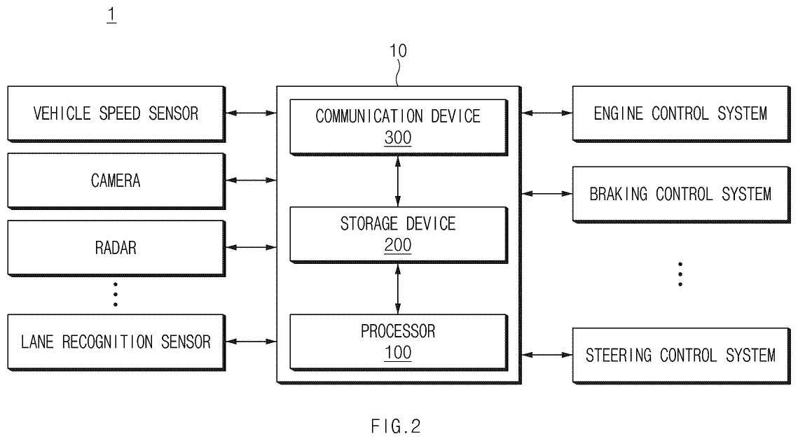

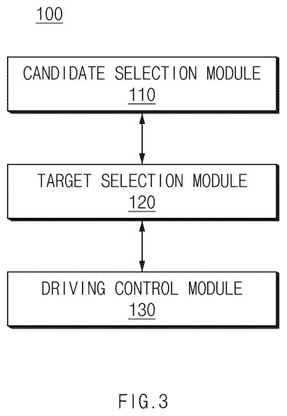

FIG. 2 shows an example of a vehicle system 1 including an autonomous driving control device 10 according to an example of the present disclosure, and FIG. 3 shows an example of a configuration of a processor 100 according to an example of the present disclosure.

Referring to FIG. 2, the autonomous driving control device 10 may include the processor 100, storage device 200, and a communication device 300 (e.g., communication interface, transceiver, etc.).

In an example, the processor 100 may select a vehicle to be yielded if it is determined based on information received via the communication device 300 that the host vehicle is located in a road merging section (e.g., based on a GPS map, a predefined geofence, or detected lane markings).

Subsequently, the processor 100 may control the driving of the host vehicle based on the driving information of the vehicle to be yielded (e.g., by adjusting speed, lane position, or acceleration behavior).

In an example, the storage device 200 may store information received via the communication device 300 and at least one instruction for execution by the processor 100. Here, the storage device 200 may store all data processed by a candidate selection module 110, a target selection module 120, and a driving control module 130 in the processor 100.

In an example, the communication device 300 may receive vehicle driving information, road information, and object information. For example, the communication device 300 may receive driving information from a vehicle speed sensor including a wheel speed sensor, an acceleration sensor, a yaw rate sensor, or the like (e.g., gyroscope, steering angle sensor, or brake pressure sensor). In addition, the communication device 300 may receive road information from a lane recognition sensor, a positioning module, a navigation system, or the like (e.g., map database, digital road model, or HD map layer). In addition, the communication device 300 may receive driving information of surrounding vehicles, as well as information on surrounding structures and objects, from a camera, radar, or similar sensors (e.g., LiDAR, ultrasonic sensor, or V2X module).

As another example, the communication device 300 may transmit and receive the above-described information to and from an autonomous driving control system including an engine control system, a braking system, and a steering control system (e.g., electric power steering module, adaptive cruise control, or electronic stability control). On the other hand, the communication device 300 may transmit a driving control signal of the vehicle generated by the processor 100 to the autonomous driving control system.

The communication device 300 may perform CAN (Controller Area Network) communication or wired communication. For example, a communication network including a body network, a multimedia network, a chassis network or the like may be formed in the vehicle for control of various control systems mounted on the vehicle and communication between the various control systems, and each of these separately separated networks may be connected by the processor 100 to transmit and receive CAN communication messages with each other. Thus, the communication device 300 may transmit a variety of information to a vehicle system and receive a variety of information from the vehicle system based on control signals from the processor 100 (e.g., engine RPM, braking status, lane departure warnings, or infotainment signals).

Referring to FIG. 3, the processor 100 may include the candidate selection module 110, the target selection module 120, and the driving control module 130.

In an example, the candidate selection module 110 may select candidates for a vehicle to be yielded based on received information. Here, at least one vehicle included in the candidates may be a candidate vehicle. For example, the candidate selection module 110 may extract the vehicle type, driving speed, steering behavior, lane departure distance, or the like of other vehicles based on object information (e.g., a sedan performing a sharp lane change, a motorcycle accelerating rapidly, or a truck drifting out of its lane). The candidate selection module 110 may select candidate vehicles based on extracted information.

The candidate selection module 110 may determine whether the vehicle is located in any of three predefined segments along the lane based on received road information (e.g., an entry buffer zone, an assessment zone, or the road merging zone).

In an example, the first to third sections may be sections set in a lane where a host vehicle is driving. The first to third sections may be set based on the position of a road merging section and the position of a candidate vehicle. For example, the first and second sections may be sections at a predetermined distance from the road merging section (e.g., 50 meters and 20 meters upstream, respectively). The third section may be the road merging section. Furthermore, if there are no vehicles expected to merge into the road merging section, the ranges of the first and second sections may be expanded (e.g., extended to cover the entire visible segment of the lane or up to a maximum buffer distance). In other words, if there are no candidate vehicles, the ranges of the first and second sections may be expanded. For example, it is assumed that a host vehicle is driving alone in a host lane where the host vehicle is driving, and there are no other vehicles in a merging road that are about to merge into the road merging section. In such a case, the third and second sections may not be set, and the first section may be set to a section from the host vehicle's current position to the road merging section.

The candidate selection module 110 may not select candidate vehicles if it is determined that a host vehicle is in the first section. The first section may be a section where the host vehicle is capable of safely driving while maintaining a constant driving speed (e.g., on a straight road with no visible merging traffic or sudden obstacles).

The candidate selection module 110 may select candidate vehicles if it is determined that the host vehicle is in the second section. For example, the candidate vehicle may be another vehicle located in the set third section (e.g., a merging SUV already approaching the convergence point). As another example, the candidate vehicle may be another vehicle located in the second section but expected to enter the third section faster than the host vehicle (e.g., a car traveling at a higher speed from an adjacent on-ramp). Here, the candidate selection module 110 may determine whether another vehicle is able to enter the third section faster than the host vehicle based on the driving speed of the other vehicle, or the like (e.g., projected arrival time, relative velocity, or acceleration trends).

In an example, the target selection module 120 may select a vehicle to be yielded if it is determined that the host vehicle is in the third section. For example, because the host vehicle enters the third section, For example, the road merging section, the target selection module 120 may not select candidate vehicles and directly select a vehicle to be yielded (e.g., based on proximity, angle of approach, or previously tracked trajectory). Alternatively, if the host vehicle is in the second section, the target selection module 120 may select candidate vehicles. Subsequently, if the host vehicle enters the third section, the target selection module 120 may select a vehicle to be yielded from among the candidate vehicles.

The target selection module 120 may select a vehicle to be yielded based on the driving information of at least one candidate vehicle. For example, the target selection module 120 may track changes in driving speed, changes in steering operation, or the like of the candidate vehicles (e.g., gradual acceleration, sudden braking, or lane curvature adjustments). Subsequently, the target selection module 120 may select a vehicle to be yielded from among the candidate vehicles based on the tracking results.

The target selection module 120 may calculate the relative position of the rear edge of a candidate vehicle with respect to the front edge of the host vehicle based on object information. For example, the target selection module 120 may calculate whether the rear edge of the candidate vehicle is located to the left or right of the front edge of the host vehicle (e.g., indicating lateral offset during merge). Further, the target selection module 120 may calculate whether the front edge of the host vehicle is in front of the rear edge of the candidate vehicle, or whether the front edge of the host vehicle is behind the rear edge of the candidate vehicle (e.g., to determine overlap, conflict zone risk, or safe yielding conditions).

The target selection module 120 may calculate a first predicted time and a second predicted time. The target selection module 120 may predict the time at which each of the candidate vehicle and the host vehicle reaches the boundary between the second section and the third section e.g., a predefined merging trigger line, a painted lane convergence point, or a GPS-defined merge zone entry). Here, the first predicted time is the time interval between the current time and the predicted time at which the candidate vehicle is expected to reach the boundary (e.g., 2.1 seconds from now if traveling at 50 km/h with 30 meters to the merge point). The second predicted time is the time obtained by adding a predetermined margin to the time interval between the current time and the predicted time at which the host vehicle is expected to reach the boundary. Here, the margin may vary depending on the relative position of the rear edge of the candidate vehicle with respect to the front edge of the host vehicle (e.g., larger margin if the vehicles are closely aligned or rapidly approaching the merge point). In addition, the target selection module 120 may calculate a threshold time calculated based on the relative position of the candidate vehicle to the host vehicle (e.g., a dynamic time window adapted to road geometry or vehicle type). Here, the threshold time may vary depending on the relative position of the rear edge of the candidate vehicle with respect to the front edge of the host vehicle.

The target selection module 120 may predict the deceleration of the host vehicle if the host vehicle is to yield to the candidate vehicle. For example, the target selection module 120 may predict the deceleration of the host vehicle assuming that each of the candidate vehicles is selected as a vehicle to be yielded (e.g., slowing from 60 km/h to 40 km/h within 2 seconds, or reducing acceleration when approaching a merging boundary). Subsequently, the target selection module 120 may determine whether the deceleration of the host vehicle is greater than a threshold. Here, the threshold may vary depending on the relative position of the rear edge of the candidate vehicle with respect to the front edge of the host vehicle (e.g., closer spacing may require a lower threshold, while distant spacing may permit more aggressive deceleration).

In an example, the target selection module 120 may determine the relative position if the host vehicle is in the second section. For example, if the host vehicle is in the second section, the target selection module 120 may receive candidate vehicles from the candidate selection module 110. On the other hand, if the vehicle is in the third section, the target selection module 120 may directly select a vehicle to be yielded (e.g., without reevaluating candidate status due to imminent merging). Subsequently, the target selection module 120 may determine whether the first predicted time is less than or equal to the second predicted time for the candidate vehicles (e.g., the candidate vehicle will reach the merge point before the host vehicle does, with acceptable delay margin).

In an example, the target selection module 120 may determine whether the first predicted time is less than or equal to the second predicted time if the front edge of the host vehicle in the second section is behind the rear edge of the candidate vehicle. Further, the target selection module 120 may determine whether the first predicted time is less than the threshold time (e.g., within a window of 1.5 seconds or less). In addition, the target selection module 120 may determine whether a predicted deceleration of the host vehicle is greater than a threshold. In addition, the target selection module 120 may determine whether the candidate vehicle is driving toward the road merging section. If all of the above-described conditions are satisfied, the target selection module 120 may select the candidate vehicle as a vehicle to be yielded (e.g., via turn signal detection, steering angle, or lane curvature). In other words, if all the aforementioned conditions are satisfied, the target selection module 120 may predict that the host vehicle will encounter the candidate vehicle in the road merging section, and thus may select the candidate vehicle as a vehicle to be yielded. However, this is only an example, and the present disclosure is not limited thereto.

In another example, the target selection module 120 may determine whether the first predicted time is less than or equal to the second predicted time if the front edge of the host vehicle is behind the rear edge of the candidate vehicle (e.g., when the host vehicle is following at a shorter longitudinal distance). Further, the target selection module 120 may determine whether the first predicted time is less than the threshold time (e.g., less than 1.5 seconds, 2.0 seconds, or a configurable time window based on traffic density). In addition, the target selection module 120 may determine whether a predicted deceleration of the host vehicle is greater than a threshold. The target selection module 120 may determine whether the candidate vehicle is driving in a different direction from the road merging section (e.g., continuing straight instead of merging, or moving into an off-ramp). If all the aforementioned conditions are satisfied, the target selection module 120 may cancel the selected candidate vehicle. For example, the target selection module 120 may exclude the candidate vehicle from the vehicle to be yielded. Alternatively, the target selection module 120 may cancel the selected candidate vehicle (e.g., by removing the vehicle from a yield-priority list or halting further tracking of its trajectory). In other words, if all the aforementioned conditions are satisfied, the target selection module 120 may predict that the host vehicle will not encounter the candidate vehicle in the road merging section (e.g., due to diverging paths, increasing separation, or non-merging behavior), and thus may cancel the selected candidate vehicle.

On the other hand, if the front edge of the host vehicle is in front of the rear edge of the candidate vehicle, the target selection module 120 may determine whether the first predicted time is less than or equal to the second predicted time. Further, the target selection module 120 may determine whether the first predicted time is less than the threshold time. In addition, the target selection module 120 may determine whether the driving speed of the candidate vehicle is greater than a threshold speed (e.g., 70 km/h in a 60 km/h zone, or higher than the host vehicle's speed by more than 10 km/h). In addition, the target selection module 120 may determine whether the candidate vehicle is driving toward the road merging section (e.g., following a merging trajectory or aligning with the host vehicle's lane). If all the aforementioned conditions are satisfied, the target selection module 120 may cancel the candidate vehicle because the candidate vehicle is about to pass via the road merging section before the host vehicle. For example, the target selection module 120 may exclude the candidate vehicle from the vehicle to be yielded. However, this is only an example, and the present disclosure is not limited thereto.

In another example, if the front edge of the host vehicle in the third section is behind the rear edge of the candidate vehicle, the target selection module 120 may calculate the distance between the lane in which the candidate vehicle is driving and the lane in which the host vehicle is driving. For example, the target selection module 120 may determine whether the distance between the lane in which the candidate vehicle is driving and the lane in which the host vehicle is driving is within a threshold range (e.g., within 3.5 meters, 2.0 meters, or a lane-width equivalent). In addition, the target selection module 120 may determine whether the candidate vehicle is driving toward the road merging section (e.g., based on trajectory prediction, steering angle, or lane-change signal detection). If all of the aforementioned conditions are satisfied, the target selection module 120 may select the candidate vehicle as a vehicle to be yielded. In other words, if all the aforementioned conditions are satisfied, the target selection module 120 may predict that the host vehicle will encounter the candidate vehicle in the road merging section, and thus may select the candidate vehicle as a vehicle to be yielded. However, this is only an example, and the present disclosure is not limited thereto.

In an example, the driving control module 130 may calculate an optimal speed based on a target speed of the host vehicle, a maximum speed of the host vehicle, and an environment of the host vehicle. Here, the target speed may be a speed set by the host vehicle, or may be a speed set by the host vehicle to reach a destination at a predetermined time (e.g., based on route ETA, navigation constraints, or user preferences). The maximum speed may be a road speed limit, or a maximum speed based on the host vehicle's autonomous driving system (e.g., limited by system calibration or road type). The optimal speed may be a speed that minimizes the risk of an accident of the host vehicle by detecting objects around the host vehicle (e.g., pedestrians, other vehicles, or static obstacles). The driving control module 130 may calculate a following speed at which the host vehicle follows a vehicle to be yielded (e.g., maintaining a gap of 2 seconds or a fixed buffer distance).

The driving control module 130 may calculate an average value of accelerations based on the calculated target speed, the maximum speed, the optimal speed, and the following speed. For example, the driving control module 130 may calculate an average value of accelerations over a one-second period for the target speed, the maximum speed, the optimal speed, and the following speed (e.g., computing a rolling average every second to smooth control decisions). Subsequently, the driving control module 130 may determine a driving speed of the host vehicle based on the calculated average value of the accelerations. For example, the driving control module 130 may calculate a minimum value of the calculated average value of the accelerations. Subsequently, the driving control module 130 may determine a driving speed of the host vehicle based on the speed having the minimum value among the target speed, the maximum speed, the optimal speed, and the following speed (e.g., choosing the speed that offers the smoothest control transition). In other words, if the following speed is the minimum value, the driving control module 130 may determine a driving speed of the host vehicle based on the following speed. The driving control module 130 may generate a driving control signal based on the determined driving speed.

At the same time, the driving control module 130 may generate a driving control signal to steer the host vehicle to avoid the vehicle to be yielded (e.g., by adjusting lane position, turn angle, or lateral acceleration). Thereafter, the driving control module 130 may transmit the driving control signal to an engine control system, a braking control system, a steering control system, and the like via the communication device 300. Accordingly, in the road merging section, the host vehicle may control its driving to allow the vehicle to be yielded to pass first (e.g., by reducing speed and increasing following distance).

As described above, the autonomous driving control device 10 according to the present disclosure may control the autonomous driving of the host vehicle by selecting a vehicle to be yielded in a road merging section, thereby reducing the awkwardness of autonomous driving and improving reliability. Furthermore, the autonomous driving control device 10 may prevent vehicle accidents occurring at the road merging section in advance (e.g., rear-end collisions, side swipes, or sudden braking incidents).

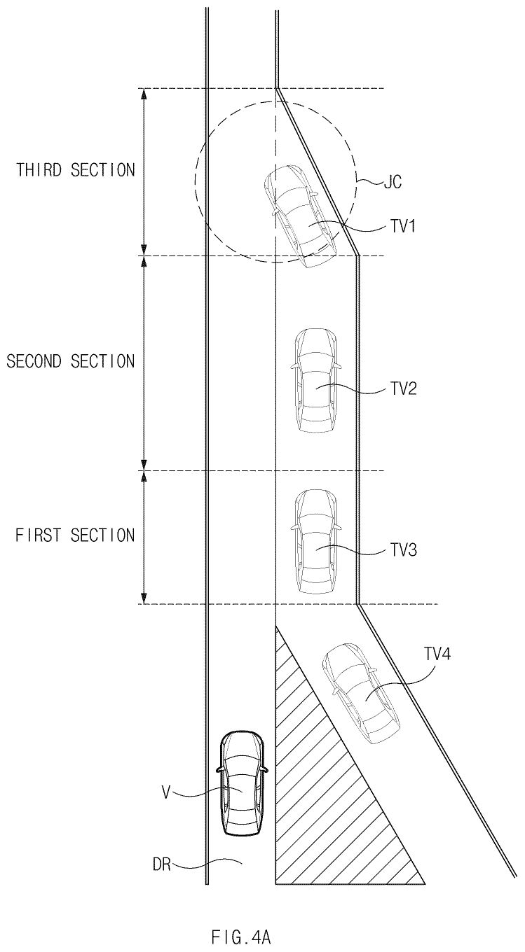

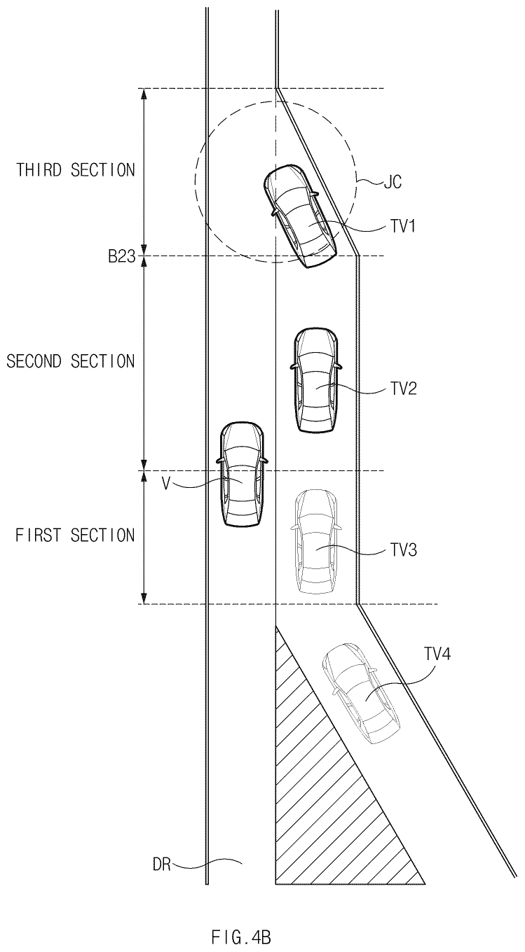

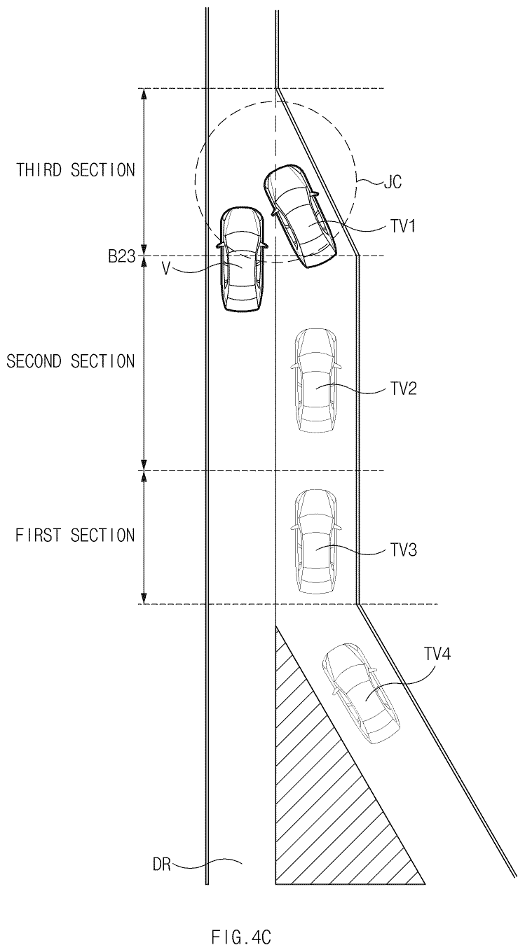

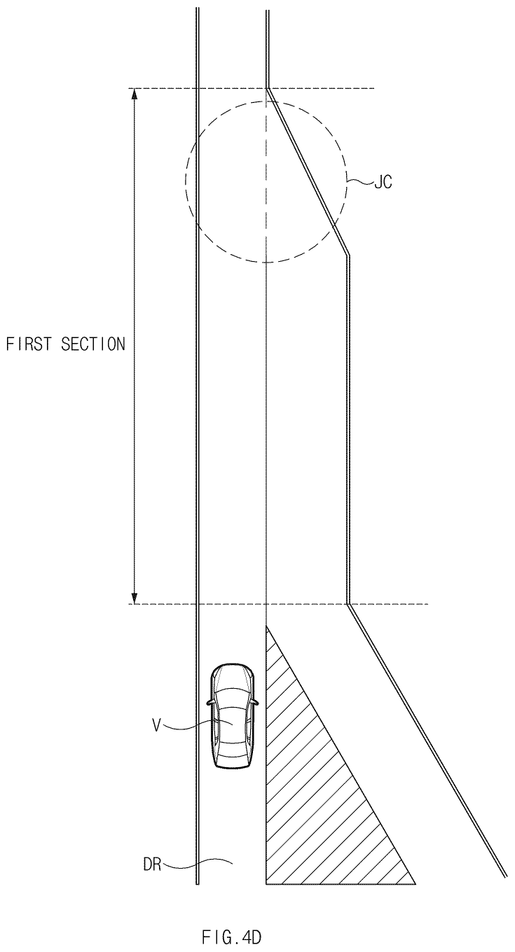

FIG. 4A, FIG. 4B, FIG. 4C, and FIG. 4D illustrate a vehicle driving in a road merging section according to an example of the present disclosure.

Referring to FIG. 4A, first to third sections may be sections set in the lane DR in which the host vehicle “V” is driving. The first to third sections may be set based on the position of the road merging section JC and the positions of candidate vehicles or other vehicles TV1 to TV4. For example, the first and second sections may be sections at a predetermined distance from the road merging section JC (e.g., 100 meters and 50 meters upstream, respectively). The third section may be the road merging section JC. In addition, if there are no vehicles expected to merge into the road merging section JC, the ranges of the first and second sections may be expanded (e.g., up to the entire visible portion of the host vehicle's lane).

If it is determined that the host vehicle “V” is in the first section, the candidate selection module 110 may not select candidate vehicles. The first section may be a section in which the host vehicle “V” safely drives while maintaining a constant driving speed (e.g., with no merging threats or conflicting traffic paths detected).

Referring to FIG. 4B, if it is determined that the host vehicle “V” is in the second section, the candidate selection module 110 may select the candidate vehicle TV1 or TV2. For example, the candidate vehicle TV1 may be another vehicle located in the set third section (e.g., a car already within the merging area preparing to merge). As another example, the candidate vehicle TV2 may be another vehicle located in the second section but expected to enter the third section faster than the host vehicle “V” (e.g., due to a higher velocity or shorter distance to the merge point). Here, the candidate selection module 110 may determine whether another vehicle is able to enter the third section faster than the host vehicle based on the driving speed of the other vehicle, or the like (e.g., real-time velocity comparison, acceleration trend, or predicted arrival time).

Subsequently, if the host vehicle “V” is in the second section, the target selection module 120 may calculate a first predicted time and a second predicted time. The target selection module 120 may predict the time at which the candidate vehicle TV2 and the host vehicle “V” reach a boundary B23 between the second section and the third section (e.g., a virtual line representing the merge threshold). Here, the first predicted time may be the time interval between the current time and the predicted time at which the candidate vehicle TV2 is expected to reach the boundary. The second predicted time may be the time obtained by adding a predetermined margin to the time interval between the current time and the predicted time at which the host vehicle “V” is expected to reach the boundary B23 (e.g., adding 0.5 seconds as a safety buffer).

Further, the target selection module 120 may calculate a threshold time calculated based on the relative position of the candidate vehicle TV1 or TV2 and the host vehicle “V” (e.g., factoring in longitudinal distance, lateral offset, or velocity difference).

The target selection module 120 may predict the deceleration of the host vehicle if the host vehicle yields to the candidate vehicle TV1 or TV2. For example, the target selection module 120 may predict the deceleration of the host vehicle “V” assuming that each candidate vehicle TV1 or TV2 is selected as a vehicle to be yielded (e.g., determining whether the host vehicle needs to reduce speed by more than 3 m/s² to allow merging). Subsequently, the target selection module 120 may determine whether the deceleration of the host vehicle “V” is greater than a threshold (e.g., a predefined safety threshold or comfort-based deceleration limit).

If the front edge of the host vehicle “V” in the second section is behind the rear edge of the candidate vehicle TV1 or TV2 (e.g., indicating that the host vehicle is following the candidate vehicle in the adjacent lane), the target selection module 120 may determine whether a first predicted time is less than or equal to a second predicted time (e.g., the candidate vehicle is expected to reach the merge boundary before or at the same time as the host vehicle). Further, the target selection module 120 may determine whether the first predicted time is less than the threshold time. The target selection module 120 may determine whether a predicted deceleration of the host vehicle “V” is greater than the threshold (e.g., within 1.5 seconds, 2.0 seconds, or another predefined safety margin). In addition, the target selection module 120 may determine whether the candidate vehicle TV1 or TV2 is driving toward the road merging section (e.g., showing a steering bias toward the merge lane or signaling intent to merge). If all of the aforementioned conditions are satisfied, the target selection module 120 may select the candidate vehicle TV1 or TV2 as a vehicle to be yielded. In other words, if all the aforementioned conditions are satisfied, the target selection module 120 may predict that the host vehicle will encounter the candidate vehicle TV1 or TV2 in the road merging section (e.g., due to converging paths, overlapping arrival times, or insufficient spacing), and thus may select the candidate vehicle TV1 or TV2 as a vehicle to be yielded. However, this is only an example, and the present disclosure is not limited thereto.

Referring to FIG. 4C, if it is determined that the host vehicle “V” is in the third section, the target selection module 120 may select the vehicle TV1 to be yielded. For example, because the host vehicle “V” has entered the third section, which is the road merging section JC, the target selection module 120 may directly select the vehicle TV1 to be yielded without selecting a candidate vehicle (e.g., due to the need for spontaneous reaction with minimal evaluation time). Alternatively, if the host vehicle is in the second section, the target selection module 120 may select the candidate vehicle TV1 or TV2. Subsequently, if the host vehicle enters the third section, the target selection module 120 may select the vehicle TV1 to be yielded from among the candidate vehicle TV1 or TV2 (e.g., giving priority to the closest vehicle in the merge path).

Referring to FIG. 4D, it is assumed that only the host vehicle “V” is driving on the host lane DR and that there are no other vehicles in a merging road that are about to merge into the road merging section. For example, the third and second sections may not be set, and the first section may be set to a section from the host vehicle's current position to the road merging section JC (e.g., when no surrounding vehicles are detected within a predefined merging zone).

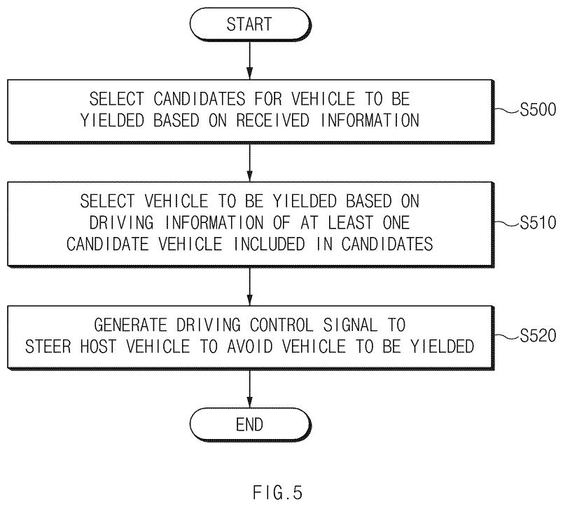

FIG. 5 shows an example of an autonomous driving control method according to an example of the present disclosure. The autonomous driving control method shown in FIG. 5 may be performed by the autonomous driving control device 10 illustrated in FIG. 2 and FIG. 3.

Referring to FIG. 5, in S500, candidates for a vehicle to be yielded may be selected based on received information. For example, the candidate selection module 110 of FIG. 3 may select candidates for a vehicle to be yielded based on the received information. Here, at least one vehicle included in the candidates may be a candidate vehicle. For example, the candidate selection module 110 may extract the vehicle type, driving speed, steering behavior, lane departure distance, or the like of other vehicles based on object information (e.g., a fast-moving sedan in a neighboring lane or a weaving motorcycle approaching the merge zone). The candidate selection module 110 may select candidate vehicles based on the extracted information.

Additionally, the candidate selection module 110 may determine whether the host vehicle is located in the first section to the third section based on the received road information (e.g., map geometry, lane configurations, or vehicle position data).

The candidate selection module 110 may not select candidate vehicles if it is determined that the host vehicle is in the first section. The first section may be a section where the host vehicle is capable of safely driving while maintaining a constant driving speed (e.g., with no anticipated merging interaction or vehicle conflicts).

The candidate selection module 110 may select candidate vehicles if it is determined that the host vehicle is in the second section. For example, the candidate vehicle may be another vehicle located in the set third section (e.g., one that has already entered the merge area). As another example, the candidate vehicle may be another vehicle located in the second section but expected to enter the third section faster than the host vehicle (e.g., based on a higher travel speed or shorter distance to the merge point). Here, the candidate selection module 110 may determine whether another vehicle is able to enter the third section faster than the host vehicle based on the driving speed of the other vehicle, or the like.

In S510, a vehicle to be yielded may be selected based on the driving information of at least one candidate vehicle included in the candidates. For example, if it is determined that the host vehicle is in the third section, the target selection module 120 of FIG. 3 may select a vehicle to be yielded. Because the host vehicle enters the third section, for example, the road merging section, the target selection module 120 may not select candidate vehicles and directly select a vehicle to be yielded (e.g., the nearest vehicle in the merge trajectory). Alternatively, if the host vehicle is in the second section, the target selection module 120 may select candidate vehicles. Subsequently, if the host vehicle enters the third section, the target selection module 120 may select a vehicle to be yielded from among the candidate vehicles (e.g., prioritizing the vehicle with the shortest predicted merge time).

The target selection module 120 may select a vehicle to be yielded based on the driving information of at least one candidate vehicle. For example, the target selection module 120 may track changes in driving speed, changes in steering operation, or the like of the candidate vehicles (e.g., rapid lane shifts, deceleration trends, or turn signal activation). Subsequently, the target selection module 120 may select a vehicle to be yielded from among the candidate vehicles based on the tracking results.

The target selection module 120 may calculate the relative position of the rear edge of a candidate vehicle with respect to the front edge of the host vehicle based on object information. For example, the target selection module 120 may calculate whether the rear edge of the candidate vehicle is located to the left or right of the front edge of the host vehicle (e.g., in an adjacent or partially overlapping lane). Further, the target selection module 120 may calculate whether the front edge of the host vehicle is in front of the rear edge of the candidate vehicle, or whether the front edge of the host vehicle is behind the rear edge of the candidate vehicle (e.g., using bounding box coordinates).

In S520, a driving control signal for the host vehicle may be generated to steer the host vehicle to avoid the vehicle to be yielded. For example, the driving control module 130 of FIG. 3 may calculate an optimal speed based on a target speed of the host vehicle, a maximum speed of the host vehicle, and an environment of the host vehicle (e.g., traffic density, road curvature, or proximity to other vehicles). The driving control module 130 may also calculate a following speed at which the host vehicle follows the vehicle to be yielded (e.g., maintaining a safe time gap of 1.5 to 2.5 seconds).

The driving control module 130 may calculate an average value of accelerations based on the calculated target speed, the maximum speed, the optimal speed, and the following speed. For example, the driving control module 130 may calculate an average value of accelerations over a one-second period for the target speed, the maximum speed, the optimal speed, and the following speed (e.g., averaging the accelerations associated with each of these speeds over a one-second period). Subsequently, the driving control module 130 may determine a driving speed of the host vehicle based on the calculated average value of the accelerations. For example, the driving control module 130 may calculate a minimum value of the calculated average value of the accelerations. Subsequently, the driving control module 130 may determine a driving speed of the host vehicle based on the speed having the minimum value among the target speed, the maximum speed, the optimal speed, and the following speed. If the following speed produces the lowest average acceleration, the vehicle will adopt the following speed as its driving speed. The driving control module 130 may generate a driving control signal based on the determined driving speed.

At the same time, the driving control module 130 may generate a driving control signal to steer the host vehicle to avoid the vehicle to be yielded. This control signal may include steering, braking, or acceleration commands to execute the yielding maneuver. Thereafter, the driving control module 130 may transmit the driving control signal to an engine control system, a braking control system, a steering control system, and the like via the communication device 300. Accordingly, in the road merging section, the host vehicle may control its driving to allow the vehicle to be yielded to pass first.

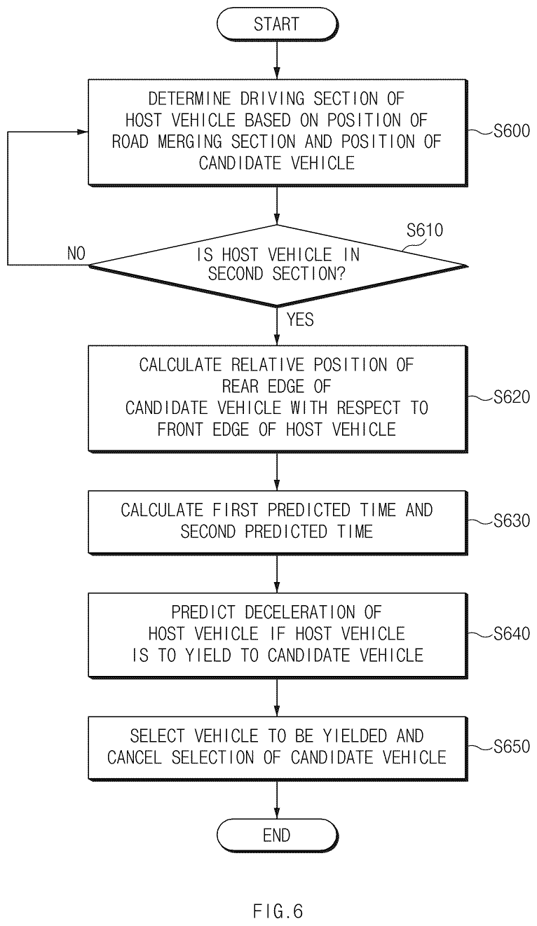

FIG. 6 is a detailed flowchart for describing the autonomous driving control method shown in FIG. 5 according to an example of the present disclosure.

Referring to FIG. 6, in S600, a driving section of a host vehicle may be determined based on the position of a road merging section and the position of a candidate vehicle. Here, the driving section may include first to third sections. The first to third sections may be set based on the position of the road merging section and the position of the candidate vehicle (e.g., these sections may be dynamically set according to real-time map data and sensor-detected vehicle positions).

In S610, it may be determined whether the host vehicle is located in the second section.

If the host vehicle is in the first or third section, the driving section of the host vehicle may be re-determined in S600 (e.g., in response to updated vehicle position or road geometry).

In an example, the candidate selection module 110 may not select candidate vehicles if it is determined that the host vehicle is in the first section. The first section may be a section where the host vehicle is capable of safely driving while maintaining a constant driving speed without risk of merging conflict.

In an example, the target selection module 120 may select a vehicle to be yielded if it is determined that the host vehicle is in the third section. For example, because the host vehicle enters the third section (e.g., the road merging section), the target selection module 120 may not select candidate vehicles and directly select a vehicle to be yielded (e.g., the one closest to the merge path).

On the other hand, if the host vehicle is in the second section, the relative position of the rear edge of the candidate vehicle with respect to the front edge of the host vehicle may be calculated in S620. For example, if the host vehicle is in the second section, the target selection module 120 may determine the relative position to anticipate merging interactions. If the vehicle is in the second section, the target selection module 120 may receive a candidate vehicle from the candidate selection module 110.

In S630, the first predicted time and the second predicted time may be calculated. For example, the target selection module 120 may calculate the first predicted time and the second predicted time. The target selection module 120 may predict the time at which each of the candidate vehicle and the host vehicle is expected to reach the boundary (e.g., a lane change entry point, a yield junction, a merging junction, or a taper zone, etc.) between the second section and the third section. Here, the first predicted time is the time interval between the current time and the predicted time at which the candidate vehicle is expected to reach the boundary. The second predicted time is the time obtained by adding a predetermined margin to the time interval between the current time and the predicted time at which the host vehicle is expected to reach the boundary. Here, the margin may vary depending on the relative position of the rear edge of the candidate vehicle with respect to the front edge of the host vehicle (e.g., how far ahead or behind the candidate vehicle is relative to the host vehicle, distance gap, overlapping range, or lane position offset, etc.). In addition, the target selection module 120 may calculate a threshold time based on the relative position of the candidate vehicle and the host vehicle (e.g., lateral offset, heading angle difference, or predicted time-to-collision, etc.). Here, the threshold time may vary depending on the relative position of the rear edge of the candidate vehicle with respect to the front edge of the host vehicle.

In S640, the deceleration of the host vehicle may be predicted if the host vehicle yields to the candidate vehicle. The target selection module 120 may predict the deceleration of the host vehicle if the host vehicle is to yield to the candidate vehicle. For example, the target selection module 120 may predict the deceleration of the host vehicle assuming that each of the candidate vehicles is selected as a vehicle to be yielded (e.g., a vehicle approaching from a merging lane, a vehicle accelerating in an adjacent lane, or a vehicle changing lanes ahead, etc.). Subsequently, the target selection module 120 may determine whether the deceleration of the host vehicle is greater than a threshold. Here, the threshold may vary depending on the relative position of the rear edge of the candidate vehicle with respect to the front edge of the host vehicle.

In S650, as the vehicle to be yielded is selected, the selection of the candidate vehicle may be canceled (e.g., removed from the list of candidate vehicles stored in memory, ignored for further evaluation, or flagged as invalid, etc.).

In an example, the target selection module 120 may determine whether the first predicted time is less than or equal to the second predicted time if the front edge of the host vehicle in the second section is behind the rear edge of the candidate vehicle (e.g., due to slower acceleration, greater following distance, or delayed lane entry, etc.). Further, the target selection module 120 may determine whether the first predicted time is less than the threshold time (e.g., 2 seconds, 1.2 seconds, or a time limit determined based on merging urgency, etc.). In addition, the target selection module 120 may determine whether a predicted deceleration of the host vehicle is greater than a threshold. In addition, the target selection module 120 may determine whether the candidate vehicle is driving toward the road merging section (e.g., via a ramp, a side lane, or a curved connector, etc.). If all of the above-described conditions are satisfied, the target selection module 120 may select the candidate vehicle as a vehicle to be yielded. In other words, if all the aforementioned conditions are satisfied, the target selection module 120 may predict that the host vehicle will encounter the candidate vehicle in the road merging section, and thus may select the candidate vehicle TV1 or TV2 as a vehicle to be yielded.

In another example, the target selection module 120 may determine whether the first predicted time is less than or equal to the second predicted time if the front edge of the host vehicle is behind the rear edge of the candidate vehicle (e.g., when the host vehicle is approaching from behind, maintaining a slower speed, or in a lagging position, etc.). Further, the target selection module 120 may determine whether the first predicted time is less than the threshold time. In addition, the target selection module 120 may determine whether a predicted deceleration of the host vehicle is greater than a threshold. The target selection module 120 may determine whether the candidate vehicle is driving in a different direction from the road merging section (e.g., exiting onto a different road, making a U-turn, or switching to a parallel lane, etc.). If all the aforementioned conditions are satisfied, the target selection module 120 may release the selected candidate vehicle. For example, the target selection module 120 may exclude the candidate vehicle from the vehicle to be yielded. Alternatively, the target selection module 120 may cancel the selected vehicle to be yielded. In other words, if all the aforementioned conditions are satisfied, the target selection module 120 may predict that the host vehicle will not encounter the candidate vehicle in the road merging section (e.g., when the candidate vehicle exits the merging lane, reduces speed significantly, or changes to a non-merging direction, etc.), and thus may cancel the selected candidate vehicle.

On the other hand, if the front edge of the host vehicle is in front of the rear edge of the candidate vehicle, the target selection module 120 may determine whether the first predicted time is less than or equal to the second predicted time. Further, the target selection module 120 may determine whether the first predicted time is less than the threshold time. The target selection module 120 may determine whether the driving speed of the candidate vehicle is greater than the threshold speed (e.g., 60 km/h, 80 km/h, or a speed limit of a merging lane, etc.). In addition, the target selection module 120 may determine whether the candidate vehicle is driving toward the road merging section (e.g., approaching from an on-ramp, moving through a curved merging lane, or transitioning from a highway exit, etc.). If all the aforementioned conditions are satisfied, the target selection module 120 may cancel the candidate vehicle because the candidate vehicle is about to pass via the road merging section before the host vehicle. For example, the target selection module 120 may exclude the candidate vehicle from the vehicle to be yielded.

As described above, the autonomous driving control method according to the present disclosure may control the autonomous driving of the host vehicle by selecting a vehicle to be yielded in a road merging section (e.g., a highway entrance ramp, a construction zone narrowing, or a lane-reduction merge, etc.), thereby reducing the awkwardness of autonomous driving and improving reliability (e.g., by ensuring smoother merging behavior, avoiding abrupt braking, or preventing hesitation at merge points, etc.). Furthermore, the autonomous driving control method may prevent vehicle accidents occurring at the road merging section in advance (e.g., rear-end collisions, side-swipes, or sudden lane changes, etc.).

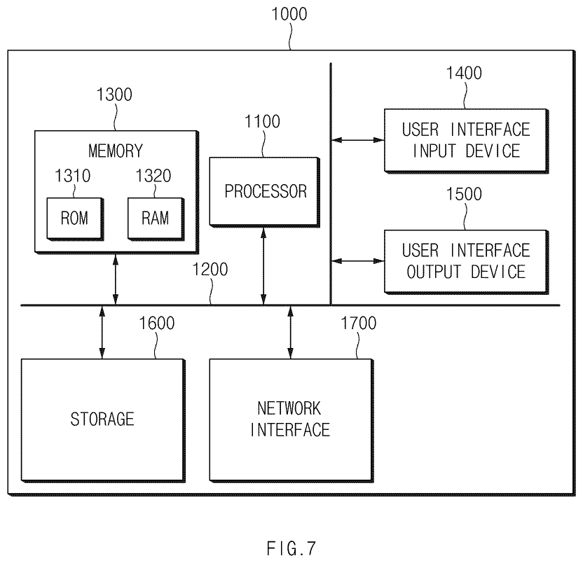

FIG. 7 is a diagram illustrating a computing system according to an example of the present disclosure.

Referring to FIG. 7, a computing system 1000 may include at least one processor 1100, a memory 1300, a user interface input device 1400, a user interface output device 1500, storage device 1600, and a network interface 1700, which are connected with each other via a bus 1200.

The processor 1100 may be a central processing unit CPU or a semiconductor device that processes instructions stored in the memory 1300 and/or the storage device 1600 (e.g., SSD, flash memory, or HDD, etc.). The memory 1300 and the storage device 1600 may include various types of volatile or non-volatile storage device media. For example, the memory 1300 may include a Read Only Memory ROM and a Random Access Memory RAM (e.g., DRAM or SRAM).

Thus, the operations of the method or the algorithm described in connection with the examples disclosed herein may be implemented in hardware or a software module executed by the processor 1100, or in a combination thereof. The software module may reside on a storage device medium For example, the memory 1300 and/or the storage device 1600 such as a RAM, a flash memory, a ROM, an EPROM, an EEPROM, a register, a hard disk, a removable disk, and a CD-ROM (e.g., SSD, USB drive, or optical media).

The exemplary storage device medium may be coupled to the processor 1100, and the processor 1100 may read information out of the storage device medium and may record information in the storage device medium. Alternatively, the storage device medium may be integrated with the processor 1100. The processor and the storage device medium may reside in an application various exemplary integrated circuit ASIC. The ASIC may reside within a user terminal (e.g., an onboard vehicle controller or mobile computing platform). In another case, the processor and the storage device medium may reside in the user terminal as separate components.

The user interface input device 1400 may include an input device that receives user inputs (e.g., to set navigation preferences, adjust climate settings, or initiate communication functions, etc.).

For example, the input device may receive various user inputs to set a vehicle's functions. For example, the input device may be implemented as a tact switch, a joystick, a push switch, a slide switch, a toggle switch, a micro switch, or a touch screen. Additionally, the input device may include a microphone to receive a user's voice input (e.g., for voice commands like “navigate home” or “call contact,” etc.).

The user interface output device 1500 may include a display that displays various information related to the vehicle's driving and/or functions, and a speaker that outputs various sounds related to the vehicle's driving and/or functions (e.g., turn-by-turn guidance, alerts, or entertainment audio, etc.).

Here, the display may provide a user interface for interaction between the user and the vehicle. For example, the display may include a Liquid Crystal Display (LCD) panel and/or a Light Emitting Diode (LED) (e.g., OLED or AMOLED panels, etc.).

The display may provide a variety of information to the user based on control signals from the processor 1100. For example, the display may be located in the central area of the vehicle's dashboard, known as the center fascia, and could be a component of the head unit or a component of a navigation device provided independently from the head unit. Here, the head unit may process and output audio and video signals and may also perform navigation functions (e.g., map rendering or traffic data processing, etc.). Therefore, the head unit may be referred to as an AVN (Audio Video Navigation) device.

For example, the display may display a route guidance screen, i.e., a screen necessary for performing navigation functions. Additionally, the display may further display a screen required to perform audio, video, or phone calling functions (e.g., playlist selection, video playback, or call history screen, etc.).

The speaker may output sounds necessary for performing navigation functions (e.g., turn instructions, traffic alerts, or system prompts, etc.).

The network interface 1700 may include a long-distance communication module and/or a short-range communication module for transmitting and receiving data with external devices (e.g., server 2 or user terminal). For example, the network interface 1700 may refer to a communication module that performs wireless Internet communication such as Wireless LAN (WLAN), Wireless Broadband (WiBro), Wi-Fi, WiMAX (World Interoperability for Microwave Access), HSDPA (High-Speed Downlink Packet Access), or the like (e.g., LTE, 5G, 6G, or Bluetooth, etc.).

For example, the user may input a destination via the user interface input device 1400, and the user interface output device 1500 may provide a route to reach the destination (e.g., displaying turn-by-turn navigation, estimated time of arrival, or traffic conditions, etc.).

According to an example of the present disclosure, an autonomous driving control device includes a communication device that receives driving information of a host vehicle, road information, and object information, a storage device that stores received information, and a processor that selects a vehicle to be yielded based on the received information if it is determined based on stored information that the host vehicle is located in a road merging section, and controls driving of the host vehicle based on driving information of the selected vehicle to be yielded.

In an example, the processor may include a candidate selection module that selects candidates for the vehicle to be yielded based on the received information, a target selection module that selects the vehicle to be yielded based on driving information of at least one candidate vehicle included in the candidates, and a driving control module that generates a driving control signal to steer the host vehicle to avoid the selected vehicle to be yielded.

In an example, the candidate selection module may not select the candidate vehicle if it is determined that the host vehicle is in a first section, and select the candidate vehicle if it is determined that the host vehicle is in a second section.

In an example, the target selection module may select the vehicle to be yielded if it is determined that the host vehicle is in a third section, and the third section may be the road merging section.

In an example, the first section to the third section may be set in a lane in which the host vehicle is driving, and the first section to the third section may be set based on a position of the road merging section and a position of the candidate vehicle.

In an example, the target selection module may calculate a relative position of a rear edge of the candidate vehicle with respect to a front edge of the host vehicle.

In an example, the target selection module may calculate a first predicted time by predicting a time at which the candidate vehicle reaches a boundary between the second section and the third section, calculate a second predicted time by predicting a time at which the host vehicle reaches the boundary, and predict a deceleration of the host vehicle if the host vehicle is to yield to the candidate vehicle.

In an example, the target selection module may determine whether the first predicted time is less than or equal to the second predicted time based on the relative position of a rear edge of the candidate vehicle with respect to a front edge of the host vehicle if the host vehicle is in the second section, and determine whether the deceleration is greater than a threshold based on the relative position.

In an example, the target selection module may select the vehicle to be yielded based on a determination result and cancel selection of the candidate vehicle.

In an example, the driving control module may calculate a target speed of the host vehicle, a maximum speed of the host vehicle, and an optimal speed based on environment of the host vehicle based on the stored information, calculate a following speed at which the host vehicle follows the vehicle to be yielded, calculate an average value of accelerations based on the target speed, the maximum speed, the optimal speed, and the following speed which are calculated, and determine a driving speed of the host vehicle based on the calculated average value of accelerations.

According to an example of the present disclosure, an autonomous driving control method includes receiving driving information of a host vehicle, road information, and object information, storing received information, and selecting a vehicle to be yielded based on the received information if it is determined based on stored information that the host vehicle is located in a road merging section, and controlling driving of the host vehicle based on driving information of the selected vehicle to be yielded.

In an example, the selecting of the vehicle to be yielded may include selecting candidates for the vehicle to be yielded based on the received information, and selecting the vehicle to be yielded based on driving information of at least one candidate vehicle included in the candidates, and the controlling of the driving of the host vehicle may further include generating a driving control signal to steer the host vehicle to avoid the selected vehicle to be yielded.

In an example, the selecting of the candidates may include not selecting the candidate vehicle if it is determined that the host vehicle is in a first section, and selecting the candidate vehicle if it is determined that the host vehicle is in a second section.

In an example, the selecting of the vehicle to be yielded may include selecting the vehicle to be yielded if it is determined that the host vehicle is in a third section, and the third section may be the road merging section.

In an example, the first section to the third section may be set in a lane in which the host vehicle is driving, and the first section to the third section may be set based on a position of the road merging section and a position of the candidate vehicle.

In an example, the selecting of the vehicle to be yielded may further include calculating a relative position of a rear edge of the candidate vehicle with respect to a front edge of the host vehicle.

In an example, the selecting of the vehicle to be yielded may include calculating a first predicted time by predicting a time at which the candidate vehicle reaches a boundary between the second section and the third section, calculating a second predicted time by predicting a time at which the host vehicle reaches the boundary, and predicting a deceleration of the host vehicle if the host vehicle is to yield to the candidate vehicle.

In an example, the selecting of the vehicle to be yielded may include determining whether the first predicted time is less than or equal to the second predicted time based on the relative position of a rear edge of the candidate vehicle with respect to a front edge of the host vehicle if the host vehicle is in the second section, and determining whether the deceleration is greater than a threshold based on the relative position.

In an example, the selecting of the vehicle to be yielded may include selecting the vehicle to be yielded based on a determination result, and canceling selection of the candidate vehicle.

In an example, the generating of the driving control signal may include calculating a target speed of the host vehicle, a maximum speed of the host vehicle, and an optimal speed based on environment of the host vehicle based on the stored information, calculating a following speed at which the host vehicle follows the vehicle to be yielded, calculating an average value of accelerations based on the target speed, the maximum speed, the optimal speed, and the following speed which are calculated, and determining a driving speed of the host vehicle based on the calculated average value of accelerations.

The above description is merely illustrative of the technical idea of the present disclosure, and various modifications and variations may be made without departing from the essential characteristics of the present disclosure by those skilled in the art to which the present disclosure pertains.

Accordingly, the example disclosed in the present disclosure is not intended to limit the technical idea of the present disclosure but to describe the present disclosure, and the scope of the technical idea of the present disclosure is not limited by the example. The scope of protection of the present disclosure should be interpreted by the following claims, and all technical ideas within the scope equivalent thereto should be construed as being included in the scope of the present disclosure.

As described above, the present technology may reduce the awkwardness of autonomous driving and improve reliability by controlling the autonomous driving of a host vehicle by selecting a vehicle to be yielded in a road merging section.

Furthermore, the present technology may prevent vehicle accidents occurring at the road merging section in advance.

In addition, various effects may be provided that are directly or indirectly understood through the disclosure.

Hereinabove, although the present disclosure has been described with reference to various examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus of a host vehicle, the apparatus comprising:
a communication interface configured to receive information associated with the host vehicle, wherein the information comprises driving information, road information, and object information;
a processor; and
a memory storing the received information and at least one instruction that, when executed by the processor communicating with the memory, is configured to cause the apparatus to:
determine, based on the stored information, that the host vehicle is in a road merging section,
based on the determination that the host vehicle is in the road merging section and the stored information, select a target vehicle to which yielding is to be performed,
output a signal indicating the target vehicle and driving information of the target vehicle, and
control, based on the signal, autonomous driving of the host vehicle.

2. The apparatus of claim 1, wherein the at least one instruction, when executed by the processor communicating with the memory, is configured to cause the apparatus to:
select, based on the stored information, a plurality of candidate vehicles from which the target vehicle is to be selected,
based on driving information of at least one candidate vehicle of the plurality of candidate vehicles, select the target vehicle among the plurality of candidate vehicles, and
steer, based on the signal, the host vehicle to yield to the target vehicle.

3. The apparatus of claim 2, wherein the at least one instruction, when executed by the processor communicating with the memory, is configured to cause the apparatus to:
based on a determination that the host vehicle is in a first section, determine not to select the plurality of candidate vehicles, and
based on a determination that the host vehicle is in a second section, select the plurality of candidate vehicles.

4. The apparatus of claim 3, wherein the at least one instruction, when executed by the processor communicating with the memory, is configured to cause the apparatus to, based on a determination that the host vehicle is in the road merging section, select the target vehicle.

5. The apparatus of claim 4, wherein the at least one instruction, when executed by the processor communicating with the memory, is configured to cause the apparatus to, based on a position of the road merging section and a position of a candidate vehicle among the plurality of candidate vehicles, define a plurality of sections along a lane in which the host vehicle is driving, and wherein the plurality of sections comprises the first section, the second section, and the road merging section.

6. The apparatus of claim 2, wherein the at least one instruction, when executed by the processor communicating with the memory, is configured to cause the apparatus to determine a relative position of a rear edge of the at least one candidate vehicle with respect to a front edge of the host vehicle.

7. The apparatus of claim 5, wherein the at least one instruction, when executed by the processor communicating with the memory, is configured to cause the apparatus to:
predict a first time at which the at least one candidate vehicle reaches a boundary between the second section and the road merging section,
predict a second time at which the host vehicle reaches the boundary, and
predict, based on the host vehicle yielding to the at least one candidate vehicle, a deceleration of the host vehicle.

8. The apparatus of claim 7, wherein the at least one instruction, when executed by the processor communicating with the memory, is configured to cause the apparatus to:
determine whether the first time is less than or equal to the second time based on a relative position of a rear edge of the at least one candidate vehicle with respect to a front edge of the host vehicle and based on the host vehicle being in the second section, and
determine, based on the relative position, whether the deceleration is greater than a threshold.

9. The apparatus of claim 2, wherein the at least one instruction, when executed by the processor communicating with the memory, is configured to cause the apparatus to, based on the determination that the host vehicle is in the road merging section and cancelation of selection of the at least one candidate vehicle, identify a vehicle ahead of the host vehicle as the target vehicle.

10. The apparatus of claim 2, wherein the at least one instruction, when executed by the processor communicating with the memory, is configured to cause the apparatus to:
determine a target speed of the host vehicle, a maximum speed of the host vehicle, and an optimal speed of the host vehicle based on environment of the host vehicle and the stored information,
determine a following speed at which the host vehicle follows the target vehicle,
determine, based on the target speed, the maximum speed, the optimal speed, and the following speed, an average value of accelerations, and
determine a driving speed of the host vehicle based on the average value of accelerations.

11. A method performed by an apparatus of a host vehicle, the method comprising:
receiving, via a communication interface of the host vehicle, information associated with the host vehicle, wherein the information comprises driving information, road information, and object information;
storing the received information;
determining, based on the stored information, that the host vehicle is in a road merging section;
based on the determining of the host vehicle being located in the road merging section and the stored information, selecting a target vehicle to which yielding is to be performed;
outputting a signal indicating the target vehicle and driving information of the target vehicle; and
controlling, based on the signal, autonomous driving of the host vehicle.

12. The method of claim 11, wherein the selecting of the target vehicle comprises:
based on the stored information, selecting a plurality of candidate vehicles from which the target vehicle to be selected; and
based on driving information of at least one candidate vehicle of the plurality of candidate vehicles, selecting the target vehicle among the plurality of candidate vehicles; and
wherein the controlling of the autonomous driving of the host vehicle comprises:
steering, based on the signal, the host vehicle to yield to the target vehicle.

13. The method of claim 12, wherein the selecting of the plurality of candidate vehicles comprises:
based on a determination that the host vehicle is in a first section, determining not to select the plurality of candidate vehicles; and
based on a determination that the host vehicle is in a second section, selecting the plurality of candidate vehicles.

14. The method of claim 13, wherein the selecting of the target vehicle comprises, based on a determination that the host vehicle is in the road merging section, selecting the target vehicle.

15. The method of claim 14, further comprising, based on a position of the road merging section and a position of a candidate vehicle among the plurality of candidate vehicles, defining a plurality of sections along a lane in which the host vehicle is driving, wherein the plurality of sections comprises the first section, the second section, and the road merging section.

16. The method of claim 12, wherein the selecting of the target vehicle comprises determining a relative position of a rear edge of the at least one candidate vehicle with respect to a front edge of the host vehicle, and selecting, based on the relative position, the target vehicle.

17. The method of claim 15, wherein the selecting of the target vehicle comprises:
predicting a first time at which the at least one candidate vehicle reaches a boundary between the second section and the road merging section;
predicting a second time at which the host vehicle reaches the boundary; and
predicting, based on the host vehicle yielding to the at least one candidate vehicle, a deceleration of the host vehicle.

18. A vehicle comprising:
a sensor;
a driving control circuit configured to control autonomous driving of the vehicle;
a processor; and
a memory storing at least one instruction that, when executed by the processor communicating with the memory, is configured to cause the vehicle to:
obtain, from the sensor, driving information of the vehicle,
determine, based on the driving information, whether the vehicle is in a road merging section of a lane in which the vehicle is traveling,
based on the determination of the vehicle being in the road merging section, select, based on the driving information, at least one candidate vehicle from at least one identified vehicle,
determine, for each candidate vehicle of the at least one candidate vehicle, whether a merging event with the vehicle is likely to occur,
based on a determination that the merging event is likely to occur, select a target vehicle from among the at least one candidate vehicle,
based on driving behavior of the target vehicle and driving environment of the vehicle, determine a following speed of the vehicle for yielding to the target vehicle,
output a signal indicating the following speed of the vehicle, and
control, via the driving control circuit and based on the signal, autonomous driving of the vehicle.

19. The vehicle of claim 18, wherein the at least one instruction, when executed by the processor communicating with the memory, is configured to cause the vehicle to determine whether the merging event is likely to occur by:
determining a relative position of a rear edge of each of the at least one candidate vehicle with respect to a front edge of the vehicle;
predicting a first time at which the at least one candidate vehicle is expected to reach a boundary between:
a merging assessment section of the lane, and
the road merging section;
predicting a second time at which the vehicle is expected to reach the boundary; and
based on the first time being earlier than the second time, for the vehicle to yield to the at least one candidate vehicle, predicting whether a deceleration of the vehicle exceeds a threshold deceleration value.

20. The vehicle of claim 18, wherein the at least one instruction, when executed by the processor communicating with the memory, is configured to cause the vehicle to:
determine a plurality of candidate speeds for the vehicle, wherein the plurality of candidate speeds comprise:
a speed at which the vehicle maintains estimated time-of-arrival,
a speed constrained by a detected road speed limit, and
a speed determined based on the at least one candidate vehicle,
determine a following speed at which the vehicle is able to maintain a safe distance from the target vehicle,
determine an average value of accelerations corresponding to each of the plurality of candidate speeds and the following speed, and
select, from among the plurality of candidate speeds and the following speed, a driving speed having a minimum average acceleration value.
